(19) United States
(12) Patent Application Publication
(10) Pub. No.: US 2025/0317256 A1
(43) Pub. Date: Oct. 9, 2025

(54) TRANSMISSION PROCESSING METHOD AND APPARATUS, AND DEVICE

(71) Applicant: VIVO MOBILE COMMUNICATION CO., LTD., Dongguan (CN)

(72) Inventors: Jian YAO, Dongguan (CN); Dajie JIANG, Dongguan (CN); Shengli DING, Dongguan (CN)

(73) Assignee: VIVO MOBILE COMMUNICATION CO., LTD., Dongguan (CN)

(21) Appl. No.: 19/246,503

(22) Filed: Jun. 23, 2025

Related U.S. Application Data
(63) Continuation of application No. PCT/CN2023/142211, filed on Dec. 27, 2023.

(30) Foreign Application Priority Data
Dec. 30, 2022 (CN) 202211739211.8

(51) Int. Cl. H04L 5/00; H04L 27/26

(52) U.S. Cl. CPC H04L 5/0053; H04L 5/0005; H04L 5/0098; H04L 27/2678

(57) ABSTRACT

A transmission processing method and apparatus and a device are provided. The method includes: generating, by a first device, a first signal based on first information, where the first information is sensing-related information; and sending, by the first device, the first signal.

### CROSS-REFERENCE TO RELATED APPLICATIONS

This application s a continuation of International Application No. PCT/CN2023/142211, filed on Dec. 27, 2023, which claims priority to Chinese Patent Application No. 202211739211.8, filed on Dec. 30, 2022. The entire contents of each of the above-referenced applications are expressly incorporated herein by reference.

### TECHNICAL FIELD

This application relates to the field of communication technologies, and in particular, to a transmission processing method and apparatus, and a device.

### BACKGROUND

In addition to a communication capability, a future mobile communication system also has a sensing capability. The sensing capability means that one or more devices with the sensing capability can sense information such as a direction, a distance, and a speed of a target object by sending and receiving wireless signals, or detect, track, identify, image, or perform another operation on a target object, an event, an environment, or the like.

However, signal design in a current communication system only considers a communication function. After introduction of a sensing function, how to generate a signal applicable to various sensing application scenarios has become a technical problem that needs to be resolved urgently.

### SUMMARY

Embodiments of this application provide a transmission processing method and apparatus and a device.

According to a first aspect, a transmission processing method is provided. The method includes:

A first device generates a first signal based on first information, where the first information is sensing-related information.

The first device sends the first signal.

According to a second aspect, a transmission processing apparatus is provided. The apparatus is used in a first device, and includes:
a first processing module, configured to generate a first signal based on first information, where the first information is sensing-related information; and
a first sending module, configured to send the first signal.

According to a third aspect, a transmission processing method is provided. The method includes:

A second device receives a second signal, where
the second signal is a first signal after being transmitted on a channel, the first signal is generated based on first information, and the first information is sensing-related information.

According to a fourth aspect, a transmission processing apparatus is provided. The apparatus is used in a second device, and includes:
a first receiving module, configured to receive a second signal, where
the second signal is a first signal after being transmitted on a channel, the first signal is generated based on first information, and the first information is sensing-related information.

According to a fifth aspect, a communication device is provided. The terminal includes a processor and a memory, and a program or instructions that can be run on the processor may be stored in the memory. The program or the instructions are executed by the processor to implement steps of the method according to the first aspect or steps of the method according to the third aspect.

According to a sixth aspect, a communication device is provided. The device includes a processor and a communication interface. The processor is configured to generate a first signal based on first information, where the first information is sensing-related information. The communication interface is configured to send the first signal.

According to a seventh aspect, a communication device is provided. The device includes a processor and a communication interface. The communication interface is configured to receive a second signal, where
the second signal is a first signal after being transmitted on a channel, the first signal is generated based on first information, and the first information is sensing-related information.

According to an eighth aspect, a communication system is provided. The system includes a first device and a second device. The first device may be configured to perform steps of the transmission processing method according to the first aspect. The second device may be configured to perform steps of the transmission processing method according to the third aspect.

According to a ninth aspect, a readable storage medium is provided. A program or instructions are stored on the readable storage medium, and the program or the instructions are executed by a processor to implement steps of the method according to the first aspect or steps of the method according to the third aspect.

According to a tenth aspect, a chip is provided. The chip includes a processor and a communication interface, the communication interface is coupled to the processor, and the processor is configured to run a program or instructions to implement the method according to the first aspect or the method according to the third aspect.

According to an eleventh aspect, a computer program/program product is provided. The computer program/program product is stored in a storage medium, and the computer program/program product is executed by at least one processor to implement steps of the method according to the first aspect or steps of the method according to the third aspect.

In the embodiments of this application, the first device generates the first signal based on the sensing-related information, and then sends the first signal. In this way, a signal applicable to sensing can be generated, and the sensing-related information is carried by using the first signal, so that a receive end can obtain the sensing-related information through detection, and signaling overheads can be reduced.

### BRIEF DESCRIPTION OF DRAWINGS

FIG. 1 is a block diagram of a wireless communication system;

FIG. 2 is a first schematic diagram of a transmission processing method according to an embodiment of this application;

FIG. 3 is a first schematic diagram of sensing area division;

FIG. 4 is a second schematic diagram of sensing area division;

FIG. 5 is a schematic diagram of a waveform of an FMCW signal;

FIG. 6 is a second schematic diagram of a transmission processing method according to an embodiment of this application;

FIG. 7 is a first schematic diagram of modules of an apparatus according to an embodiment of this application;

FIG. 8 is a second schematic diagram of modules of an apparatus according to an embodiment of this application;

FIG. 9 is a schematic structural diagram of a communication device according to an embodiment of this application;

FIG. 10 is a schematic structural diagram of a terminal according to an embodiment of this application; and

FIG. 11 is a schematic structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA) system, a Time Division Multiple Access (TDMA) system, a Frequency Division Multiple Access (FDMA) system, an Orthogonal Frequency Division Multiple Access (OFDMA) system, and a Single-carrier Frequency Division Multiple Access (SC-FDMA) system. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} Generation (6G) communication system.

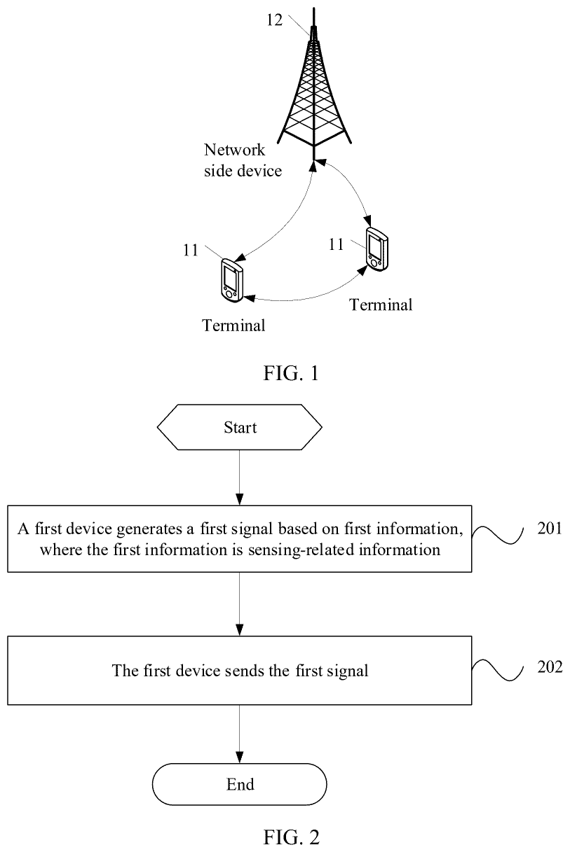

FIG. 1 is a block diagram of a wireless communication system to which embodiments of this application may be applied. The wireless communication system includes a terminal 11 and a network side device 12. The terminal 11 may be a terminal side device such as a mobile phone, a tablet computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Network (WLAN) access point, a Wi-Fi node, or the like. The base station may be referred to as a NodeB, an Evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another appropriate term in the field. As long as a same technical effect is achieved, the base station is not limited to a specified technical term. It should be noted that, in the embodiments of this application, only a base station in an NR system is used as an example for description, and a specific type of the base station is not limited.

For ease of understanding, some content involved in the embodiments of this application is described below.

### I. Integrated Sensing and Communication

In addition to a communication capability, a future mobile communication system, for example, a Beyond 5^{th} Generation (B5G) communication system or 6G communication system, also has a sensing capability. The sensing capability means that one or more devices with the sensing capability can sense information such as a direction, a distance, and a speed of a target object by sending and receiving wireless signals, or detect, track, identify, image, or perform another operation on a target object, an event, an environment, or the like. In the future, with deployment of millimeter-wave and terahertz small base stations or the like with high-frequency band and large-bandwidth capabilities in 6G networks, a resolution of sensing is significantly improved in a case of being compared with that of a centimeter-wave base station, so that the 6G network can provide a more precise sensing service. Typical sensing functions and application scenarios are shown in Table 1.

TABLE 1

| Sensing function | Application scenario |
|---|---|
| Weather conditions, air quality, | Meteorology, agriculture, and life |
| and the like | services |
| Traffic flow (intersections) and | Intelligent traffic and commercial |
| pedestrian flow (subway | services |
| entrances) | |
| Target tracking, ranging, speed | Many application scenarios for |
| measurement, contours, and the | conventional radars |
| like | |
| Environment reconstruction | Intelligent driving and navigation |
| | (cars/unmanned aerial vehicles), |
| | smart cities (3D maps), and network |
| | planning and optimization |
| Action/posture/expression | Intelligent interaction of |
| recognition | smartphones, games, and smart homes |
| Heartbeat/breathing and the like | Health and medical care |
| Imaging, material detection, | Security inspection, industry, |
| component analysis, and the like | biological medicine, and the like |

Integrated sensing and communication means that in a same system, a design of integrated communication and sensing functions is implemented through spectrum sharing and hardware sharing. In a case that information is transmitted, the system can sense information such as a direction, a distance, and a speed, and detect, track, and identify a target device or an event. A communication system and a sensing system cooperate with each other, to improve overall performance and bring better service experience.

Integration of communication and a radar is a typical application of integrated sensing and communication. In the past, a radar system and a communication system were strictly distinguished due to different research objects and focuses, and the two systems were independently studied in most scenarios. Actually, the radar system and the communication system are both typical means for sending, obtaining, processing, and exchanging information, and have many similarities in terms of working principles, system architectures, and frequency bands. An integrated design of communication and a radar is quite feasible, which is mainly embodied in the following aspects: First, both the communication system and the sensing system are based on the electromagnetic wave theory, and transmitting and receiving of an electromagnetic wave are used to complete information obtaining and transmission. Second, both the communication system and the sensing system have structures such as an antenna, a transmit end, a receive end, and a signal processor, and overlap to a great extent in terms of hardware resources. With development of technologies, the communication system and the sensing system are increasingly overlapping in terms of working frequency bands. In addition, the communication system and the sensing system have similarities in terms of key technologies such as signal modulation and reception detection and waveform design. Fusion of the communication system and the radar system can bring many advantages, such as reducing costs, reducing sizes, reducing power consumption, improving spectrum efficiency, and reducing mutual interference, thereby improving overall system performance.

Based on different sending nodes and receiving nodes of sensing signals, the following six sensing links are obtained through division. It should be noted that for each sensing link, one sending node and one receiving node are used as an example. In an actual system, different sensing links may be selected based on different sensing requirements. There may be one or more sending nodes and receiving nodes for each sensing link, and the actual sensing system may include a plurality of different sensing links. People and vehicles are used as examples of sensing objects, and sensing objects of the actual system are richer.
(1) Base station self-transmitting and self-receiving sensing: In this manner, a base station sends a sensing signal, and obtains a sensing result by receiving an echo of the sensing signal.
(2) Inter-base station air interface sensing: In this case, a base station 2 receives a sensing signal sent by a base station 1, and obtains a sensing result.
(3) Uplink air interface sensing: In this case, a base station receives a sensing signal sent by User Equipment (UE, also known as a terminal), and obtains a sensing result.
(4) Downlink air interface sensing: In this case, UE receives a sensing signal sent by a base station, and obtains a sensing result.
(5) Terminal self-transmitting and self-receiving sensing: In this case, UE sends a sensing signal, and obtains a sensing result by receiving an echo of the sensing signal.
(6) Inter-terminal sidelink sensing: For example, UE 2 receives a sensing signal sent by UE 1, and obtains a sensing result.

A transmission processing method and apparatus and a device provided in the embodiments of this application are described below in detail with reference to the accompanying drawings by using some embodiments and application scenarios thereof.

As shown in FIG. 2, a transmission processing method according to an embodiment of this application includes the following steps.

Step 201: A first device generates a first signal based on first information, where the first information is sensing-related information.

In this step, the first signal is generated based on the sensing-related information, and the generated signal is associated with sensing.

Step 202: The first device sends the first signal.

In this step, the first device sends the first signal generated in step 201. Herein, the first signal is used for sensing measurement, or for sensing measurement and communication.

In this way, according to the foregoing steps 201 and 202, the first device generates the first signal based on the sensing-related information, and then sends the first signal. In this way, a signal applicable to sensing can be generated, and the sensing-related information is carried by using the first signal, so that a receive end can obtain the sensing-related information through detection, and signaling overheads can be reduced.

For example, in this embodiment, the first information includes at least one of the following:
a sensing area identifier;
an identifier indicating whether the first signal is used for sensing;
a sensing service identifier;
a sensing service type identifier;
a sensing target identifier;
a tag identifier associated with a sensing target;
a sensing measurement quantity identifier;
a device identifier participating in sensing measurement;
a cell identifier;
time domain resource information;
frequency domain resource information; and
a codeword number.

In other words, the first device can generate the first signal based on one or more of the foregoing items, so that interference between signals for communication and sensing, different sensing services, different sensing areas, different sensing targets, and the like is randomized, which is applicable to various sensing application scenarios and improves sensing performance.

In this embodiment, the first information is received by the first device from a second device or another device, or may be determined by the first device.

For example, the sensing area identifier is used to indicate at least one of the following:
a sensing area including a plurality of base station coverage areas;
a sensing area under a single base station coverage area;
a sensing area corresponding to a specific angle range of a single base station; and
a geographical area identifier.

It should be known that in this embodiment, a sensing area is a to-be-sensed target area, and may be obtained through division in advance. The sensing area identifier is an Identifier (ID) associated with each sensing area after division. The sensing area identifier may be denoted as n_{areaID}.

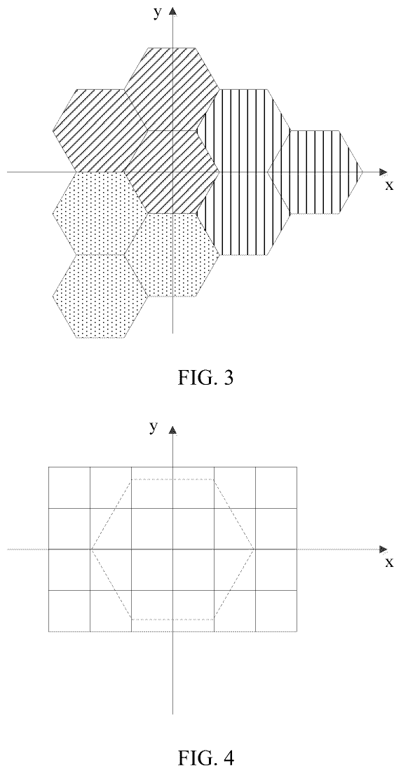

In an implementation, the sensing area is a sensing area including a plurality of base station coverage areas (cells), and is associated with one sensing area identifier. For example, as shown in FIG. 3, each hexagonal area represents a base station coverage area, and areas filled with a same background represent a same sensing area. In particular, a Radio Access Network (RAN)-based notification area (RNA) may be used as a sensing area, and an RNA ID may be used as a sensing area identifier.

In an implementation, the sensing area is a plurality of sensing areas included in a single base station coverage area (cell), and is associated with a plurality of sensing area identifiers. For example, the base station is used as the origin, a coverage range of the base station is rasterized and divided into the plurality of sensing areas, and each sensing area is associated with an area ID (n_{areaID}). As shown in FIG. 4, dotted lines represent the coverage area of the base station, and each square represents a divided sensing area.

In an implementation, the sensing area is an area corresponding to a geographic area identifier (for example, a longitude and latitude or a coordinate position), and is associated with a sensing area identifier.

In an implementation, the sensing area is areas corresponding to different angle ranges of a base station, and is associated with different sensing area identifiers. For example, an azimuth angle from x1° to x2° and an elevation angle from y1° to y2° correspond to a sensing area ID 1.

For example, in this embodiment, the identifier indicating whether the first signal is used for sensing (denoted as n_{sensing1ID}) may use different values to indicate whether the first signal is used for sensing. For example, n_{sensing1ID}=0 or 1. In a case that the first signal is not used for sensing, n_{sensing1ID}=0. In a case that the first signal is used for sensing, n_{sensing1ID}=1.

For example, in this embodiment, the sensing service identifier (denoted as n_{sensing2ID}) is an identifier pre-allocated for a different sensing service, and different sensing services correspond to different sensing service identifiers. For example, a sensing service initiated by a sensing requester is a sensing service 2, and corresponds to n_{sensing2ID}. In this case, a sending device generates a first signal based on n_{sensing2ID}, and sends the first signal to a receiving end, that is, the second device.

A sensing service may be at least one of the following:
detection of whether a target exists, positioning, speed detection, distance detection, angle detection, acceleration detection, material analysis, component analysis, shape detection, category classification, Radar Cross Section (RCS) detection, polarimetric scattering characteristic detection, fall detection, intrusion detection, quantity statistics, indoor positioning, gesture recognition, lip reading recognition, gait recognition, expression recognition, facial recognition, breathing monitoring, heart rate monitoring, pulse monitoring, humidity/brightness/temperature/atmospheric pressure monitoring, air quality monitoring, weather condition monitoring, environment reconstruction, topography, building/vegetation distribution detection, pedestrian flow or traffic flow detection, crowd density, vehicle density detection, and the like.

For example, in this embodiment, the sensing service type identifier (denoted as n_{sensing3ID}) is an identifier of a sensing service type, and different types of sensing services correspond to different sensing service type identifiers. For example, sensing services are classified into the following three types based on ranges.
1. A first type (close distance/small range): material analysis, component analysis, gesture recognition, lip reading recognition, gait recognition, expression recognition, facial recognition, breathing monitoring, heart rate monitoring, pulse monitoring, and the like.
2. A second type (medium distance/medium range): intrusion detection, quantity statistics, indoor positioning, and the like.
3. A third type (long distance/large range): humidity/brightness/temperature/atmospheric pressure monitoring, air quality monitoring, weather condition monitoring, environment reconstruction, topography, building/vegetation distribution detection, pedestrian flow or traffic flow detection, and the like.

In some embodiments, a classification standard of sensing services may be classification into positioning sensing, imaging sensing, recognition sensing, and the like based on functions, or may be classification based on power consumption/energy consumption, classification based on resource occupation, or the like.

In addition, in this embodiment, the identifier indicating whether the first signal is used for sensing, the sensing service identifier, and the sensing service type identifier may be all denoted as n_{sensingID}.

For example, in this embodiment, the sensing target identifier is an identifier of a sensing target, and is denoted as n_{targetID}, and different sensing targets correspond to different sensing target IDs. The first device obtains the sensing target identifier, which may be prior information obtained based on an existing measurement result. For example, the first device (a base station A) sends a sensing measurement signal through an omnidirectional beam for preliminary measurement; and the base station A obtains a distance-Doppler map (or a distance-angle map or the like), determines a quantity of targets (sensing targets) based on the distance-Doppler map, and allocates an ID to each target. In some embodiments, the first device (a base station A) sends a sensing measurement signal through an omnidirectional beam for preliminary measurement; and a receive end (for example, another base station or a terminal) obtains a distance-Doppler map (or a distance-angle map or the like), determines a quantity of targets (sensing targets) based on the distance-Doppler map, allocates an ID to each target, and then notifies the sending base station of the target ID and/or target-related information.

After determining the sensing target identifier, the first device generates a signal for sensing the corresponding sensing target. In addition, generated first signals corresponding to different sensing targets are sent using different beams, and a beam direction points to the sensing target associated with the sensing target identifier.

In some embodiments, the sensing target identifier may be an identifier of a sensing target type. Different types of sensing targets correspond to different sensing target IDs. For example, sensing targets are divided into stationary targets and moving targets based on motion states. Moving targets may be further divided into high-speed targets and low-speed targets based on speeds. Different types of targets correspond to different n_{targetID}.

For example, in this embodiment, the tag identifier associated with the sensing target may be a tag ID associated with a tag installed on the sensing target, and different tags are associated with different tag IDs. The first device obtains tag IDs corresponding to sensing targets, and then obtains signals for sensing different sensing targets. A tag may be a device supporting backscatter communication, and an excitation source of the tag may be a device other than the tag, or the excitation source may be the tag itself. The tag may be UE, in other words, a common transceiver module is installed on the sensing target, for example, a communication device (such as a vehicle-mounted terminal) is installed on a vehicle.

For example, in this embodiment, the sensing measurement quantity identifier is an identifier corresponding to one or more sensing measurement quantities. For example, a mapping table between sensing measurement quantity IDs and sensing measurement quantities is preset, as shown in Table 2 below.

TABLE 2

| Sensing measurement quantity ID | Sensing measurement quantity |
|---|---|
| ID 1 | Delay/Distance |
| ID 2 | Doppler/Speed |
| ID 3 | Angle |
| ID 4 | Delay/Distance, Doppler/speed |
| ID 5 | Delay/Distance, Doppler/speed, angle |
| . . . | . . . |

For example, in this embodiment, the device identifier participating in sensing measurement is an identifier of a device participating in sensing measurement, such as an identifier of the first device, an identifier of the second device (receive end device), an identifier of a sensing server, or the like. The first device is UE and/or the second device is UE, and the identifier of the first device or the second device may be a Radio Network Temporary Identifier (RNTI).

For example, in this embodiment, the cell identifier may be an identifier of a cell corresponding to a base station in a case that the first device is a base station and/or the second device is a base station, and may be an identifier of a cell in which the sensing target is located or the like.

For example, in this embodiment, the time domain resource information includes at least one of the following:
a system frame number, a subframe number, a slot number, a symbol number, duration, time domain density, a Cyclic Prefix (CP) type, and a CP length; and
the frequency domain resource information includes at least one of the following:
a Resource Element (RE) index, a Resource Block (RB) index, carrier frequency information, frequency band information, a bandwidth, frequency domain density, and a subcarrier spacing.

Herein, the time domain resource information and/or the frequency domain resource information may be time domain resource information and/or frequency domain resource information for sending a second signal.

For example, in this embodiment, the first signal includes at least one of the following:
a signal generated based on a PN sequence;
a signal generated based on a ZC sequence; and
a signal generated based on a chirp signal.

Herein, the Pseudo-noise (PN) sequence may be considered as a pseudo-random sequence, and the ZC sequence is a Zadoff-Chu sequence.

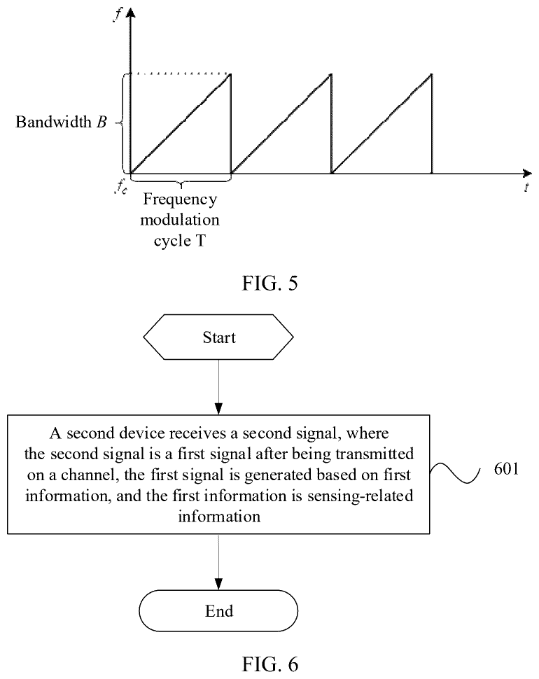

It should be noted that a Frequency Modulated Continuous Wave (FMCW) signal is a waveform whose frequency changes with time, usually in a linear manner; and a frequency modulation cycle of the FMCW waveform is usually also referred to as a chirp, as shown in FIG. 5. In other words, the chirp signal may be used to generate an FMCW signal, and a signal generated based on the chirp signal may also be a signal generated based on the FMCW signal.

For example, in a case that the first signal includes the signal generated based on the PN sequence, the first information is associated with an initial value of the PN sequence.

In other words, that the first device generates the first signal based on the first information includes: determining the initial value of the PN sequence based on the first information, and generating the first signal based on the initial value of the PN sequence.

In an implementation, the initial value (cᵢₙᵢₜ) of the PN sequence may be obtained based on the first information (such as the sensing area identifier). Examples are as follows:

$${c}_{init} = {n}_{a r e a I D} , \qquad ( 1 )$$

where n_{areaID} is the sensing area identifier.

$${c}_{init} = ( {2}^{x} ( {N}_{symb}^{s l o t} {n}_{sf}^{μ} + l + 1 ) + {n}_{areaID} ) \qquad ( 2 )$$

mod 2^{A}, where

$${N}_{s y m b}^{slot}$$

is a quantity of symbols in each slot,

$${n}_{s , f}^{μ}$$

is quantity of slots in each frame during configuration of the subcarrier spacing, l is a symbol number in the slot, and x is a non-negative positive integer. The coefficient parameter 2^{x} may be determined based on value ranges of other variables and values of other coefficient parameters in the formula. For example, if there are 1000 sensing area IDs in total and the IDs need to be represented by a 10-bit binary number, x=10 may be set to ensure that no repeated scrambling initial value appears. A is a non-negative positive integer, and A is preset. For example, A=31 is set.

$${c}_{init} = {2}^{x} ( {N}_{symb}^{slot} {n}_{s , f}^{μ} + l + 1 ) ( 2 {N}_{I D}^{cell} + 1 ) + {2}^{y} {N}_{I D}^{cell} + {n}_{a r e a I D} , \qquad ( 3 )$$

where

$${N}_{I D}^{cell}$$

is a physical cell identifier, and x and y are non-negative positive integers; or

$${c}_{i n i t} = {2}^{x} ( {N}_{s ymb}^{slot} {n}_{s , f}^{μ} + l + 1 ) ( 2 {n}_{a r e a I D} + 1 ) + {2}^{y} {n}_{a r e a I D} + {N}_{I D}^{cell} .$$

$${c}_{i n i t} = ( {2}^{x} {n}_{R N T I} + {n}_{areaID} ) mod {2}^{A} , \qquad ( 4 )$$

where n_{RNTI} is terminal identifier in a device participating in sensing measurement, x and A are non-negative positive integers, and A may be set to be equal to 31.

$${c}_{i n i t} = ( {2}^{x} {n}_{RNTI} + {2}^{y} {N}_{ID}^{cell} + {n}_{a r e a I D} ) mod {2}^{A} ; or \\ {c}_{i n i t} = {2}^{x} {n}_{R N T I} + {2}^{y} {n}_{a r e a I D} + {N}_{I D}^{cell} or \\ {c}_{i n i t} = ( {2}^{x} {n}_{R N T I} + {2}^{y} {n}_{a r e a I D} + {N}_{I D}^{cell} ) \qquad ( 5 )$$

mod 2^{A}, where x, y, and A are non-negative positive integers, and A=31 may be set.

$${c}_{i n i t} = ( {2}^{x} {n}_{R N T I} + {2}^{y} q + {2}^{z} {N}_{I D}^{cell} + {n}_{a r e a I D} ) mod {2}^{A} , \qquad ( 6 )$$

where q is a codeword number; or

$${c}_{i n i t} = ( {2}^{x} {n}_{R N T I} + {2}^{y} q + {2}^{z} {n}_{a reaID} + {N}_{I D}^{cell} )$$

mod 2^{A}, where x, y, z, and A are non-negative positive integers, and A=31 may be set.

In addition, the initial value of the PN sequence may be determined based on another item in the first information. For example, n_{areaID} is replaced with n_{sen sin gID}, Or n_{areaID} is replaced with n_{targetID}. In some embodiments, the initial value of the PN sequence may be determined based on two or more items in the first information. For example,

$${c}_{i n i t} = ( {2}^{x} ( {N}_{s ymb}^{slot} {n}_{s , f}^{μ} + l + 1 ) + {2}^{x} {n}_{areaID} + {n}_{targetID} ) mod {2}^{A} .$$

In some embodiments, a manner of generating the initial value of the PN sequence based on one or more items in the first information is not limited to the foregoing content, which is not listed one by one herein.

It should be noted that in this embodiment, the PN sequence is generated in the following manner: c(n)=(x₁(n+NC)+x₂(n+N_{C}))mod2, x₁(n+31)=(x₁(n+3)+x₁(n) mod2, and x₂(n+31)=(x₂(n+3)+x₂(n+2)+x₂(n+1)+x₂(n))mod2, where n=0, 1, . . . , M_{PN}−1, and MPN is a sequence length. N_{c}=1600, an initialization manner of a 1^{st} m sequence x₁(n) is x₁(0)=1, x₁(n)=0, n=1,2, . . . , 30, and an initialization manner of a 2^{nd} m sequence x₂(n) is

$${c}_{i n i t} = {\sum }_{i = 0}^{30} {x}_{2} ( i ) \cdot {2}^{j} .$$

After the PN sequence is generated, the PN sequence is further modulated to obtain the first signal. For example, QPSK modulation is performed:

$$r ( n ) = \frac{1}{\sqrt{2}} ( 1 - 2 \cdot c ( 2 n ) ) + j \frac{1}{\sqrt{2}} ( 1 - 2 \cdot c ( 2 n ) + 1 ) , 0 \leq n \leq M ,$$

where M is a length of the first signal.

In some embodiments, a pseudo-random sequence is generated based on the initial value of the PN sequence that is determined in the foregoing manner, a sequence \tilde{r}_{u,v}(i) is generated through π/2 Binary Phase Shift Keying (BPSK) modulation based on the pseudo-random sequence c(i), then a base sequence

$${\overline{r}}_{u v} ( n ) ( {\overline{r}}_{u v} ( n ) = \frac{1}{\sqrt{M}} {\sum }_{j = 0}^{M - 1} {\tilde{r}}_{u v} ( i ) {e}^{- j \frac{2 π in}{M}} )$$

is generated based on the sequence, and then the first signal r(n) is generated based on the base sequence: r(n)=r̅_{u,v}(n), 0≤n<M, where M is a length of the sensing signal. Compared with the previous manner, in this manner, the generated first signal has a smaller peak to Peak to Average Power Ratio (PAPR) and higher power amplifier efficiency, which is conducive to improving sensing measurement coverage performance.

It should be further noted that in a case of multi-device joint sensing in a same sensing area, a plurality of devices use a common sensing area ID to generate first signals. For example, generation of the first signals is irrelevant to a cell identifier or a UE identifier. To be specific, different first devices may use a same first signal generation parameter (including but not limited to first information) to further construct code-division orthogonal first signals (for example, different devices generate a same first sensing signal based on the same generation parameter, then further generate mutually orthogonal second sensing signals (that is, the first signals) based on different Orthogonal Covering Code (OCC), and use the second sensing signals for sensing measurement). Second devices may obtain the first signals based on the same first signal generation parameter and in a code-division orthogonal manner, and perform measurement. In this way, interference between signals of different devices is reduced, and signaling overheads can be reduced, thereby improving measurement efficiency. It is assumed that a device A and a device B are in a same sensing area, and the device A and the device B, serving as first devices, use a same first signal generation parameter (for example, a sensing area identifier) to generate first signals. For example, a Frequency Domain-Orthogonal Covering Code (FD-OCC) is used as an example. After the device A and the device B both generate a first sensing signal c(m) based on the same sensing area identifier, the device A generates a second sensing signal 1 based on c(m) and a first OCC sequence (1, 1, 1, 1, . . . , 1, 1, 1, 1) according to a formula c(m)*occ(m), where the second sensing signal 1 is a first signal of the device A; and the device B generates a second sensing signal 2 based on c(m) and a second OCC sequence (1, −1, 1, −1, . . . , 1, −1, 1, −1) according to the formula c(m)*occ(m), where the second sensing signal 2 is a first signal of the device B. m=0, 1, 2, . . . , M−1, and M represents the length of the first signal. In this way, the first signal of the device A and the first signal of the device B are orthogonal.

For example, in a case that the first signal includes the signal generated based on the ZC sequence, the first information is associated with a root sequence number and/or a cyclic shift value of the ZC sequence.

In other words, that the first device generates the first signal based on the first information includes: determining the root sequence number and/or the cyclic shift value of the ZC sequence based on the first information, and generating the first signal based on the root sequence number and/or the cyclic shift value of the ZC sequence. Compared with the first signal generated based on the PN sequence, first signal generated based on the ZC sequence has a smaller PAPR and higher power amplifier efficiency, which is conducive to improving sensing measurement coverage performance.

In an implementation, association between the first information (for example, the sensing area identifier) and the root sequence number q and/or the cyclic shift value a of the ZC sequence is implemented as follows:
(1) The root sequence number q or the cyclic shift value a is calculated based on all or a part of bits of the sensing area identifier. Assuming that the sensing area identifier is an 8-bit ID, all or a part of the eight bits may be used to calculate the root sequence number q or the cyclic shift value a of the sequence. For example, the cyclic shift value a may be determined by the first four bits of the sensing area ID, and the root sequence number q is determined by the last four bits of the ID.
(2) The root sequence number q is determined based on a mapping relationship between the root sequence number q and the sensing area identifier. A mapping relationship between different sensing area identifiers and different root sequence numbers q is shown in Table 3 below. The mapping relationship is agreed upon, or the second device obtains the mapping relationship by using a signaling message. In this case, the cyclic shift value a may be determined based on the sensing service identifier.

TABLE 3

| Sensing area ID | Root sequence number q |
|---|---|
| ID 1 | X1 |
| ID 2 | X2 |
| . . . | . . . |

(3) The root sequence number q or the cyclic shift value α is calculated according to a formula. For example,
the root sequence number q is calculated as:

$$q = ⌊ \overline{q} + 1 / 2 ⌋ + v \cdot {( - 1 )}^{⌊ 2 \overline{q} ⌋}$$

$$\overline{q} = {N}_{Z C} \cdot ( u + 1 ) / 31$$

u∈{0,1, . . . ,29} is a group number, v is a base sequence number in a group, μ=(n_{arealD})mod 3 0 and v=0.

The cyclic shift value a is calculated as:

$$α = 2 π \frac{{n}_{areaID}}{{n}_{areaID}^{max}} , wher e {n}_{areaID}^{max}$$

is a maximum value of the sensing area identifier, or a fixed value greater than the maximum value of the sensing area identifier.

In addition, the root sequence number and/or the cyclic shift value of the ZC sequence may be determined based on another item in the first information. For example, n_{areaID} is replaced with n_{sensingID}, or n_{areaID} is replaced with n_{targetID}. In some embodiments, the root sequence number and/or the cyclic shift value of the ZC sequence may be determined based on two or more items in the first information. In some embodiments, a manner of generating the root sequence number and/or the cyclic shift value of the ZC sequence based on one or more items in the first information is not limited to the foregoing content, which is not listed one by one herein.

After the root sequence number q of the ZC sequence is determined,

$${x}_{q} ( m ) = \text{?}$$

$$\text{?} \text{indicates text missing or illegible when filed}$$

is first determined based on the root sequence number q; then a base sequence r̅_{u,v}(n) is obtained, where r̅_{u,v}(n)=x_{q}(n mod N_{ZC}), 0≤n<M and N_{2C} is a maximum prime number less than the sequence length M; and then the first signal r(n) is obtained through cyclic shifting: r(n)=e^{jgm}r̅_{u,v}(n). 0≤n<M. M is related to a resource of the first signal. For example, it is determined based on a bandwidth and a frequency domain resource interval of the first signal that a quantity of resource units used to transmit the first signal is M.

For example, in a case that the first signal includes the signal generated based on the chirp signal, the first information is associated with a frequency modulation slope and/or a start frequency of the chirp signal.

In other words, that the first device generates the first signal based on the first information includes: determining the frequency modulation slope and/or the start frequency of the chirp signal based on the first information, and generating the first signal based on the frequency modulation slope and/or the start frequency of the chirp signal.

The chirp signal may be represented by the following formula:

$$s ( t ) = {A}_{0} exp ( j 2 π ( {f}_{c} t + \frac{1}{2} {kt}^{2} ) ) ,$$

where A₀ is an amplitude, f_{c} is the start frequency, k is the frequency modulation slope, k=B/T, B is a bandwidth, and Tis duration of the chirp signal (for example, a frequency modulation cycle of the FMCW signal).

In an implementation, association between the first information and the frequency modulation slope of the chirp signal may be implemented as follows: a mapping relationship between different sensing service IDs and different frequency modulation slopes is predefined or configured based on different requirements of different sensing services for a bandwidth and duration of a chirp signal (for example, different requirements for a frequency modulation slope). Association between the first information and the start frequency of the chirp signal may be implemented as follows: a mapping relationship between different sensing areas and different start frequencies is predefined or configured.

In some embodiments, a mapping relationship between another item of the first information and the frequency modulation slope and/or the start frequency of the chirp signal may be predefined or configured.

In this embodiment, the second device is a receive end of the first signal, and the second device receives the second signal (the first signal after being transmitted on a channel).

For example, after the second device receives the second signal, the method further includes: generating the first signal based on the first information; obtaining a sensing measurement result based on the first signal and the second signal.

In other words, the second device can generate the first signal based on the first information with the first device. A detailed implementation is not described herein. In this way, the second device can obtain the sensing measurement result based on the first signal generated by the second device and the received second signal. For example, channel information is obtained based on the first signal and the second signal, and then the sensing measurement result is obtained based on the channel information. The second device may further send the obtained sensing measurement result.

For example, in this embodiment, the method further includes:

The first device sends the first information.

In other words, the second device may receive the first information sent by the first device. Therefore, the second device can directly generate the first signal based on the received first information. In some embodiments, the first information received by the second device may be sent by another device.

In an implementation, the first device sends first signaling, where the first signaling is used to notify the second device of the first information.

For example, in this embodiment, the method further includes:

The first device sends a candidate set of the first information.

In other words, the second device may receive the candidate set of the first information that is sent by the first device, and then determine the first information based on the candidate set. Therefore, the second device can detect the second signal based on the received candidate set of the first information, to determine the first information.

For example, the second device generates a plurality of first signals based on the candidate set of the first information, then separately performs, for example, correlation detection on the plurality of first signals and the second signal, and determines the first information associated with the second signal through comparison of correlation peak values with a preset threshold.

In some embodiments, the candidate set of the first information that is received by the second device may be sent by another device; or the candidate set of the first information is predefined or configured.

In an implementation, the first device sends second signaling, where the second signaling is used to notify the candidate set of the first information. If the first information is the sensing area identifier, the set of the first information is a set including a plurality of different sensing area identifiers. A plurality of first signals are determined based on different sensing area identifiers, then, for example, correlation detection is separately performed on the plurality of first signals and the second signal, and a sensing area identifier associated with the second signal is determined through comparison of correlation peak values with a preset threshold.

For example, in a case that the second signal is detected based on the candidate set to obtain a detection result, and the detection result does not meet the preset threshold or the detection result indicates that a decoding error occurs, the second device sends a detection failure indication to the first device.

The detection failure indication is used to indicate the first device to perform at least one of the following:
resending the first signal; and
sending the first information.

In this way, the first device receives the detection failure indication, and resends the first signal and/or sends the first information.

The detection result may be a correlation peak value, and the detection result not meeting the preset threshold may be that all correlation peak values obtained through correlation detection do not meet a corresponding preset threshold requirement.

For example, in this embodiment, the first device sends first configuration information, where the first configuration information is used to receive the second signal, and the first configuration information includes at least one of the following:
a signal resource identifier;
a waveform;
a subcarrier spacing;
a guard interval;
time domain resource information and/or frequency domain resource information;
signal power;
sequence information;
a signal direction; and
a quasi co-location relationship.

In this way, the second device receives the first configuration information sent by the first device, and receives the second signal based on the first configuration information. In some embodiments, the second device may also receive first configuration information sent by another device.

The signal resource identifier is used to distinguish between different signal resource configurations. The waveform may be Orthogonal frequency division multiplexing (OFDM), Single-carrier Frequency-Division Multiple Access (SC-FDMA), Orthogonal Time Frequency Space (OTFS), Frequency Modulated Continuous Wave (FMCW), a pulse signal, or the like. The subcarrier spacing may be a subcarrier spacing 30 kHz in an OFDM system.

The guard interval is a time interval between a moment at which sending of a signal ends and a moment at which a latest echo signal of the signal is received. The parameter is proportional to a maximum sensing distance, and for example, may be calculated according to c/(2Rₘₐₓ), where Rₘₐₓ is the maximum sensing distance (which is sensing requirement information). For example, for a self-transmitting and self-receiving sensing signal, Rₘₐₓ represents a maximum distance from a receive point of the sensing signal to a transmit point of the signal. In some cases, a cyclic prefix (CP) of an OFDM signal may serve as a minimum guard interval. c is a speed of light. The frequency domain resource information includes: a frequency domain start position, that is, a start frequency, which may also be a start RE or RB index; a frequency domain resource length, that is, a frequency domain bandwidth, where the frequency domain bandwidth is inversely proportional to a distance resolution, and a frequency domain bandwidth of each first signal is B≥c/(2ΔR), where c is the speed of light and ΔR is a distance resolution; and a frequency domain resource interval, where the frequency domain resource interval is inversely proportional to a maximum unambiguous distance/delay, where for the OFDM system, in a case that subcarriers are continuously mapped, a frequency domain interval is equal to a subcarrier spacing. The time domain resource information includes: a time domain start position, that is, a start time point, which may also be a start symbol, slot, or frame index; a time domain resource length, also known as burst duration, where the time domain resource length is inversely proportional to a Doppler resolution; and a time domain resource interval, where the time domain resource interval is a time interval between two adjacent signals, and the time domain resource interval is associated with a maximum unambiguous Doppler frequency shift or a maximum unambiguous speed. For the signal power, for example, one value is taken every two dBm from −20 dBm to 23 dBm. The sequence information includes type information of a used generation sequence (for example, the ZC sequence or the PN sequence), and a generation manner. The signal direction includes angle information or beam information for signal sending. The Quasi Co-Location (QCL) relationship may mean that each of a plurality of resources (third signal resources) is QCLed with a Synchronization Signal Block (SSB), where QCL includes Type A, B, C or D.

In an implementation, the first configuration information is indicated by using third signaling.

For example, in this embodiment, the first device sends second configuration information, where the second configuration information is used for sensing measurement and/or reporting of the sensing measurement result, and the second configuration information includes at least one of the following:
a sensing measurement quantity;
a reported time domain resource and/or a reported frequency domain resource;
a reporting manner; and
a reporting triggering condition.

In this way, the second device receives the second configuration information sent by the first device, performs sensing measurement based on the second configuration information, and/or reports the sensing measurement result. In some embodiments, the second device may also receive second configuration information sent by another device.

The reporting manner includes: periodic reporting, where reporting is performed according to a specified time offset and/or cycle; semi-persistent reporting, where reporting is performed according to a specified cycle after a reporting start indication is received, until a reporting stop indication is received, where the reporting start indication is used to indicate the start of corresponding sensing reporting, and the reporting stop indication is used to indicate the stop of reporting; and aperiodic reporting, where reporting is performed at a specified moment or in a case that a preset condition is met.

The reporting triggering condition may be that the sensing measurement result or sensing performance corresponding to the sensing measurement result meets a preset condition. For example, the sensing measurement result meets a preset interval range, or a power value of a signal component associated with the sensing target meets a preset threshold.

In an implementation, the second configuration information is indicated by using fourth signaling.

In this embodiment, the first signaling, the second signaling, the third signaling, and the fourth signaling may be combined into one piece of signaling or a plurality of pieces of signaling.

In this embodiment, the sensing measurement result refers to a measurement result of a corresponding sensing measurement quantity, that is, a value of the sensing measurement quantity. Sensing measurement quantities may be divided into the following types:
(a) first-level measurement quantities (received signals/original channel information), including: a received signal/channel response complex result, an amplitude/phase, an in-phase/quadrature component and an operation result thereof (operations include addition, subtraction, multiplication, division, matrix addition, matrix subtraction, matrix multiplication, matrix transposition, a trigonometric operation, a square root operation, a power operation, a threshold detection result and a maximum/minimum value extraction result of the operation result, and the like; and the operations further include Fast Fourier Transform (FFT)/Inverse Fast Fourier Transform (IFFT), Discrete Fourier Transform (DFT)/Inverse Discrete Fourier Transform (IDFT), 2D-FFT, 3D-FFT, matched filtering, an autocorrelation operation, wavelet transform, digital filtering, a threshold detection result and a maximum/minimum value extraction result of the operation result, and the like);
(b) second-level measurement quantities (basic measurement quantities), including: a delay, Doppler, an angle, intensity, and a multi-dimensional combination representation thereof;
(c) third-level measurement quantities (basic attributes/statuses), including: a distance, a speed, a direction, a spatial location, and an acceleration; and
(d) fourth-level measurement quantities (advanced attributes/statuses), including: target presence, a trajectory, an action, an expression, a vital sign, a quantity, an imaging result, weather, air quality, a shape, a material, and a composition.

For example, in this embodiment, the first device includes a base station or a terminal, and the second device includes a base station or a terminal.

In this embodiment, a sending device of the signaling and/or a receiving device of the sensing measurement result may be implemented in the following cases:
1. The first device sends the signaling to the second device and/or receives the sensing measurement result from the second device. In this case, the first device (signal sending device) and the second device (signal receiving device) are different devices. For example,
the first device is a base station, and the second device is a terminal; or
the first device is a base station A, and the second device is a base station B; or
the first device is a terminal A, and the second device is a terminal B.
2. A first device sends the signaling to the second device and/or receives the sensing measurement result from the second device. In this case, the first device and the second device are different devices. For example,
the first device is a base station, the second device is a terminal, and the third device is a sensing network function; or
the first device is a base station A, the second device is a base station B, and the third device is a sensing network function; or
the first device is a terminal A, the second device is a terminal B, and the third device is a sensing network function or a base station; or
the first device is a terminal, the second device is a base station, and the third device is a sensing network function.
3. A third device sends the signaling to the second device and/or receives the sensing measurement result from the second device. In this case, the first device and the second device are a same device. For example,
the first device and the second device are a base station A, and the third device is a sensing network function; or
the first device and the second device is a terminal A, and the third device is a sensing network function or a base station.

Signaling transmission between the base station and the terminal or between the terminal A and the terminal B is implemented via Radio Resource Control (RRC) signaling, a Media Access Control (MAC) Control Element (CE), layer 1 signaling, or other newly defined sensing signaling; signaling transmission between the sensing network function and the terminal may be implemented via Non-Access Stratum (NAS) signaling (forwarded by an Authentication Management Function (AMF)) and/or RRC signaling, a MAC CE, layer 1 signaling, or other newly defined sensing signaling; interaction between the sensing network function and the base station may be implemented through forwarding from an AMF to a wireless access network through an N2 interface, sending from the core network sensing network function to a User Plane Function (UPF), sending from the UPF to the wireless access network through an N3 interface, or sending to the wireless access network (base station) through a newly defined interface; and signaling transmission between base stations may be implemented through an Xn interface.

The sensing network function is described as follows:

The sensing network function, also known as a sensing network element or a Sensing Management Function (Sensing MF), may be located on a RAN side or a core network side, is a network node, in the core network and/or the RAN, that is responsible for at least one of functions such as sensing request processing, sensing resource scheduling, sensing information interaction, and sensing data processing, and may be upgraded based on an AMF or a Location Management Function (LMF) in a 5G network, or may be another network node or a newly defined network node. For example, functional characteristics of the sensing network function/sensing network element may include at least one of the following:
(1) exchanging target information with a wireless signal sending device and/or a wireless signal measuring device (including a target terminal, a serving base station of the target terminal, or a base station associated with a target area), where the target information includes a sensing processing request, a sensing capability, sensing auxiliary data, a sensing measurement quantity type, sensing resource configuration information, and the like, to obtain a value of a target sensing result or sensing measurement quantity (uplink measurement quantity or downlink measurement quantity) sent by the wireless signal measuring device, where a wireless signal may also be referred to as a sensing signal;
(2) determining a to-be-used sensing method based on factors such as a sensing service type, sensing service consumer information, required sensing Quality of Service (QoS) requirement information, a sensing capability of the wireless signal sending device, and a sensing capability of the wireless signal measuring device, where the sensing method may include: A base station A performs sending and a base station B performs receiving, a base station performs sending and a terminal performs receiving, a base station A performs both sending and receiving, a terminal performs sending and a base station performs receiving, a terminal performs both sending and receiving, a terminal A performs sending and a terminal B performs receiving, or the like;
(3) determining a sensing device serving the sensing service based on factors such as the sensing service type, the sensing service consumer information, the required sensing QoS requirement information, the sensing capability of the wireless signal sending device, and the sensing capability of the wireless signal measuring device, where the sensing device includes the wireless signal sending device and/or the wireless signal measuring device;
(4) managing overall coordination and scheduling of resources required for the sensing service, for example, configuring sensing resources of the base station and/or the terminal accordingly; and
(5) performing data processing on the value of the sensing measurement quantity, or performing calculation to obtain the sensing result, and further verifying the sensing result, estimating sensing precision, and so on.

In conclusion, according to the method in this embodiment of this application, the first device generates the first signal based on the first information, so that interference between signals for communication and sensing, different sensing services, different sensing areas, different sensing targets, and the like is randomized, which is applicable to various sensing application scenarios and improves sensing performance. For multi-device joint sensing, the same first signal generation parameter (including but not limited to the first information) may be used to further construct the code-division orthogonal first signals, and the second devices may obtain the first signals based on the same first signal generation parameter and in a code-division orthogonal manner, and perform measurement. In this way, interference between signals of different devices is reduced, and signaling overheads can be reduced, thereby improving measurement efficiency. In another aspect, the first information may be further carried by using the first signal, and the second device obtains the first information through detection on the second signal, so that signaling overheads brought by explicit indication can be reduced. In another aspect, an encryption function is achieved, in other words, a device that does not know the first signal generation parameter cannot accurately perform sensing, so that sensing security is improved.

As shown in FIG. 6, a transmission processing method according to an embodiment of this application includes the following steps.

Step 601: A second device receives a second signal.

The second signal is a first signal after being transmitted on a channel, the first signal is generated based on first information, and the first information is sensing-related information.

Herein, the second signal received by the second device is the first signal after being transmitted on the channel, the first signal is generated based on the first information, and the first information is sensing-related information. In this way, the generated first signal is applicable to sensing, and the sensing-related information is carried by using the first signal, so that a receive end can obtain the sensing-related information through detection, and signaling overheads can be reduced.

For example, the first information includes at least one of the following:
a sensing area identifier;
an identifier indicating whether the first signal is used for sensing;
a sensing service identifier;
a sensing service type identifier;
a sensing target identifier;
a tag identifier associated with a sensing target;
a sensing measurement quantity identifier;
a cell identifier;
a device identifier participating in sensing measurement;
time domain resource information;
frequency domain resource information; and
a codeword number.

For example, the sensing area identifier is used to indicate at least one of the following:
a sensing area including a plurality of base station coverage areas;
a sensing area under a single base station coverage area;
a sensing area corresponding to a specific angle range of a single base station; and
a geographical area identifier.

For example, the time domain resource information includes at least one of the following:
a system frame number, a subframe number, a slot number, a symbol number, duration, time domain density, a CP type, and a CP length; and
the frequency domain resource information includes at least one of the following:
an RE index, an RB index, carrier frequency information, frequency band information, a bandwidth, frequency domain density, and a subcarrier spacing.

For example, the first signal includes at least one of the following:
a signal generated based on a PN sequence;
a signal generated based on a ZC sequence; and
a signal generated based on a chirp signal.

For example, in a case that the first signal includes the signal generated based on the PN sequence, the first information is associated with an initial value of the PN sequence.

For example, in a case that the first signal includes the signal generated based on the ZC sequence, the first information is associated with a root sequence number and/or a cyclic shift value of the ZC sequence.

For example, in a case that the first signal includes the signal generated based on the chirp signal, the first information is associated with a frequency modulation slope and/or a start frequency of the chirp signal.

For example, after the second device receives the second signal, the method further includes:

The second device generates the first signal based on the first information; and
the second device obtains a sensing measurement result based on the first signal and the second signal.

The second device can generate the first signal based on the first information with the first device. A detailed implementation is not described herein. In this way, the second device can obtain the sensing measurement result based on the first signal generated by the second device and the received second signal. For example, channel information is obtained based on the first signal and the second signal, and then the sensing measurement result is obtained based on the channel information.

For example, before the second device generates the first signal based on the first information, the method includes:

The second device receives the first information; or
the second device obtains a candidate set of the first information, and detects the second signal based on the candidate set to determine the first information.

In this way, the second device can directly generate the first signal based on the received first information. The second device can further detect the second signal based on the received candidate set of the first information, to determine the first information.

For example, the second device generates a plurality of first signals based on the candidate set of the first information, then separately performs, for example, correlation detection on the plurality of first signals and the second signal, and determines the first information associated with the second signal through comparison of correlation peak values with a preset threshold.

That the first information is the sensing service ID is used as an example. It is assumed that a quantity of candidate sensing services is n, which corresponds to n sensing service identifiers (the set of the first information): {n_{sen sin gID1}, n_{sen sin gID2}, . . . , n_{sen sin gIDn}}, where the set of the first information may be predefined, that is, the first device and the second device (transmit end and receive end) know all the candidate sensing services and the corresponding identifiers; or may be sent by the first device (transmit device) or another device to the second device (receive device). A sensing service initiated by a sensing requester is a sensing service 2, which corresponds to n_{sen sin gID2}. In this case, the first device generates an initial value (cᵢₙᵢₜ) of the PN sequence and a first signal based on n_{sen sin gID2}, and sends the first signal to the second device.

The second device respectively generates n local signals (first signals) based on n_{sen sin gID1}, n_{sen sin gID2}, . . . , and n_{sen sin gIDn}, and performs correlation detection with the received second signal. It may be considered that a first signal obtained based on n_{sen sin gID2} is highly correlated with the second signal, and a correlation peak value exceeding a preset threshold can be obtained, so that the second device may determine a specific sensing service identifier n_{sen sin gID2}.

The first information is sent by the first device, or is sent by another device. The candidate set of the first information may be predefined or configured, or may be sent by the first device or another device.

For example, the method further includes:
in a case that the second signal is detected based on the candidate set to obtain a detection result, and the detection result does not meet a preset threshold or the detection result indicates that a decoding error occurs, sending, by the second device, a detection failure indication to a first device, where

The detection failure indication is used to indicate the first device to perform at least one of the following:
resending the first signal; and
sending the first information.

For example, before the second device receives the second signal, the method further includes:

The second device receives first configuration information, where the first configuration information is used to receive the second signal, and the first configuration information includes at least one of the following:
a signal resource identifier;
a waveform;
a subcarrier spacing;
a guard interval;
time domain resource information and/or frequency domain resource information;
signal power;
sequence information;
a signal direction; and
a quasi co-location relationship.

For example, the method further includes:

The second device receives second configuration information, where the second configuration information is used for sensing measurement and/or reporting of the sensing measurement result, and the second configuration information includes at least one of the following:
a sensing measurement quantity;
a reported time domain resource and/or a reported frequency domain resource;
a reporting manner; and
a reporting triggering condition.

For example, in this embodiment, the first device includes a base station or a terminal, and the second device includes a base station or a terminal.

It should be noted that the method is implemented in cooperation with the method performed by the first device, and the implementations of the embodiment of the transmission processing method performed by the first device are applicable to this method, and same technical effects can also be achieved. Details are not described herein.

The transmission processing method provided in this embodiment of this application may be performed by a transmission processing apparatus. In the embodiments of this application, the transmission processing apparatus according to an embodiment of this application is described by using an example in which the transmission processing apparatus performs the transmission processing method.

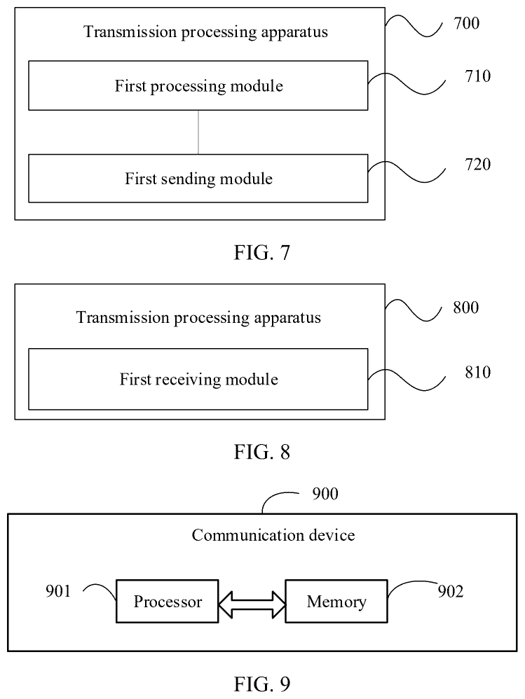

As shown in FIG. 7, a transmission processing apparatus 700 according to an embodiment of this application includes:
a first processing module 710, configured to generate a first signal based on first information, where the first information is sensing-related information; and
a first sending module 720, configured to send the first signal.

For example, the first information includes at least one of the following:
a sensing area identifier;
an identifier indicating whether the first signal is used for sensing;
a sensing service identifier;
a sensing service type identifier;
a sensing target identifier;
a tag identifier associated with a sensing target;
a sensing measurement quantity identifier;
a cell identifier;
a device identifier participating in sensing measurement;
time domain resource information;
frequency domain resource information; and
a codeword number.

For example, the sensing area identifier is used to indicate at least one of the following:
a sensing area including a plurality of base station coverage areas;
a sensing area under a single base station coverage area;
a sensing area corresponding to a specific angle range of a single base station; and
a geographical area identifier.

For example, the time domain resource information includes at least one of the following:
a system frame number, a subframe number, a slot number, a symbol number, duration, time domain density, a cyclic prefix CP type, and a CP length; and
the frequency domain resource information includes at least one of the following:
a resource element RE index, a resource block RB index, carrier frequency information, frequency band information, a bandwidth, frequency domain density, and a subcarrier spacing.

For example, the first signal includes at least one of the following:
a signal generated based on a PN sequence;
a signal generated based on a ZC sequence; and
a signal generated based on a chirp signal.

For example, in a case that the first signal includes the signal generated based on the PN sequence, the first information is associated with an initial value of the PN sequence.

For example, in a case that the first signal includes the signal generated based on the ZC sequence, the first information is associated with a root sequence number and/or a cyclic shift value of the ZC sequence.

For example, in a case that the first signal includes the signal generated based on the chirp signal, the first information is associated with a frequency modulation slope and/or a start frequency of the chirp signal.

For example, the apparatus further includes:
a second sending module, configured to send the first information.

For example, the apparatus further includes:
a third sending module, configured to send a candidate set of the first information.

The apparatus generates the first signal based on the sensing-related information, and then sends the first signal. In this way, a signal applicable to sensing can be generated, and the sensing-related information is carried by using the first signal, so that a receive end can obtain the sensing-related information through detection, and signaling overheads can be reduced.

The transmission processing apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not limited in this embodiment of this application.

The transmission processing apparatus provided in this embodiment of this application can implement the processes implemented in the method embodiment of FIG. 2, with the same technical effect achieved. To avoid repetition, details are not described herein again.

As shown in FIG. 8, a transmission processing apparatus 800 according to an embodiment of this application includes:
a first receiving module 810, configured to receive a second signal, where
the second signal is a first signal after being transmitted on a channel, the first signal is generated based on first information, and the first information is sensing-related information.

For example, the first information includes at least one of the following:
a sensing area identifier;
an identifier indicating whether the first signal is used for sensing;
a sensing service identifier;
a sensing service type identifier;
a sensing target identifier;
a tag identifier associated with a sensing target;
a sensing measurement quantity identifier;
a cell identifier;
a device identifier participating in sensing measurement;
time domain resource information;
frequency domain resource information; and
a codeword number.

For example, the sensing area identifier is used to indicate at least one of the following:
a sensing area including a plurality of base station coverage areas;
a sensing area under a single base station coverage area;
a sensing area corresponding to a specific angle range of a single base station; and
a geographical area identifier.

For example, the time domain resource information includes at least one of the following:
a system frame number, a subframe number, a slot number, a symbol number, duration, time domain density, a cyclic prefix CP type, and a CP length; and
the frequency domain resource information includes at least one of the following:
a resource element RE index, a resource block RB index, carrier frequency information, frequency band information, a bandwidth, frequency domain density, and a subcarrier spacing.

For example, the first signal includes at least one of the following:
a signal generated based on a PN sequence;
a signal generated based on a ZC sequence; and
a signal generated based on a chirp signal.

For example, in a case that the first signal includes the signal generated based on the PN sequence, the first information is associated with an initial value of the PN sequence.

For example, in a case that the first signal includes the signal generated based on the ZC sequence, the first information is associated with a root sequence number and/or a cyclic shift value of the ZC sequence.

For example, in a case that the first signal includes the signal generated based on the chirp signal, the first information is associated with a frequency modulation slope and/or a start frequency of the chirp signal.

For example, the apparatus further includes:
a second processing module, configured to generate the first signal based on the first information; and
a third processing module, configured to obtain a sensing measurement result based on the first signal and the second signal.

For example, the apparatus further includes:
a second receiving module, configured to receive the first information; or
a fourth processing module, configured to: obtain a candidate set of the first information, and detect the second signal based on the candidate set to determine the first information.

For example, the apparatus further includes:
a fourth sending module, configured to: in a case that the second signal is detected based on the candidate set to obtain a detection result, and the detection result does not meet a preset threshold or the detection result indicates that a decoding error occurs, send a detection failure indication to a first device, where
the detection failure indication is used to indicate the first device to perform at least one of the following:
resending the first signal; and
sending the first information.

For example, the apparatus further includes:
a third receiving module, configured to receive first configuration information, where the first configuration information is used to receive the second signal, and the first configuration information includes at least one of the following:
a signal resource identifier;
a waveform;
a subcarrier spacing;
a guard interval;
time domain resource information and/or frequency domain resource information;
signal power;
sequence information;
a signal direction; and
a quasi co-location relationship.

For example, the apparatus further includes:
a fourth receiving module, configured to receive second configuration information, where the second configuration information is used for sensing measurement and/or reporting of the sensing measurement result, and the second configuration information includes at least one of the following:
a sensing measurement quantity;
a reported time domain resource and/or a reported frequency domain resource;
a reporting manner; and
a reporting triggering condition.

The second signal received by the apparatus is the first signal after being transmitted on the channel, the first signal is generated based on the first information, and the first information is sensing-related information. In this way, the generated first signal is applicable to sensing, and the sensing-related information is carried by using the first signal, so that a receive end can obtain the sensing-related information through detection, and signaling overheads can be reduced.

The transmission processing apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not limited in this embodiment of this application.

The transmission processing apparatus provided in this embodiment of this application can implement the processes implemented in the method embodiment of FIG. 6, with the same technical effect achieved. To avoid repetition, details are not described herein again.

For example, as shown in FIG. 9, an embodiment of this application further provides a communication device 900, including a processor 901 and a memory 902. The memory 902 stores a program or instructions that can be run on the processor 901. For example, in a case that the communication device 900 is a first device, the program or the instructions are executed by the processor 901 to implement steps in the embodiment of the transmission processing method performed by the first device, and a same technical effect can be achieved. In a case that the communication device 900 is a second device, the program or the instructions are executed by the processor 901 to implement steps in the embodiment of the transmission processing method performed by the second device, and a same technical effect can be achieved. To avoid repetition, details are not described herein again.

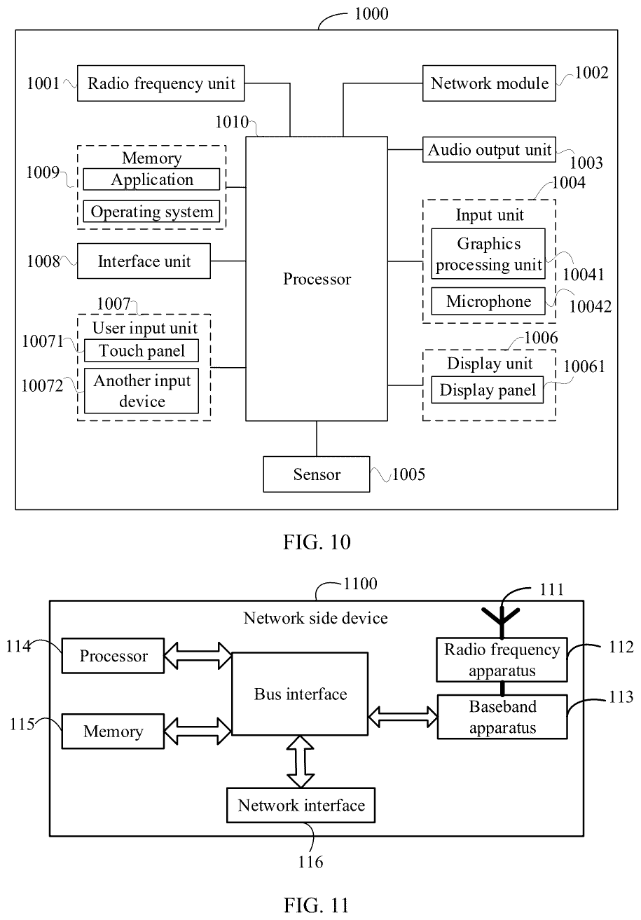

An embodiment of this application further provides a communication device. The device includes a processor and a communication interface. The processor is configured to generate a first signal based on first information, where the first information is sensing-related information. The communication interface is configured to send the first signal. This embodiment of the communication device corresponds to the method embodiment on a first device side. Each implementation process and implementation of the method embodiment are applicable to this embodiment of the communication device, and same technical effects can be achieved. For example, FIG. 10 is a schematic diagram of a hardware structure of a terminal serving as a first device for implementing embodiments of this application.

The terminal 1000 includes but is not limited to at least a part of components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

It is understood that the terminal 1000 may further include a power supply (such as a battery) that supplies power to each component. The power supply may be logically connected to the processor 1010 by using a power supply management system, to implement functions such as charging and discharging management, and power consumption management by using the power supply management system. The terminal structure shown in FIG. 10 constitutes no limitation on the terminal, and the terminal may include more or fewer components than those shown in the figure, or combine some components, or have different component arrangements. Details are not described herein.

It should be understood that in this embodiment of this application, the input unit 1004 may include a Graphics Processing Unit (GPU) 10041 and a microphone 10042. The graphics processing unit 10041 processes image data of a static picture or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1001 may transmit the downlink data to the processor 1010 for processing. In addition, the radio frequency unit 1001 may send uplink data to the network side device. Generally, the radio frequency unit 1001 includes but is not limited to an antenna, an amplifier, a transceiver, a coupler, a low noise amplifier, a duplexer, and the like.

The memory 1009 may be configured to store a software program or instructions and various data. The memory 1009 may mainly include a first storage area for storing a program or instructions and a second storage area for storing data. The first storage area may store an operating system, and an application or instructions required by at least one function (for example, a sound playing function or an image playing function). In addition, the memory 1009 may be a volatile memory or a non-volatile memory, or the memory 1009 may include a volatile memory and a non-volatile memory. The non-volatile memory may be a Read-Only Memory (ROM), a programmable read-only memory (PROM), an erasable programmable read-only memory (EPROM), an electrically erasable programmable read-only memory (EEPROM), or a flash memory. The volatile memory may be a Random Access Memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 1009 in this embodiment of this application includes but is not limited to these memories and any memory of another proper type.

The processor 1010 may include one or more processing units. For example, an application processor and a modem processor are integrated into the processor 1010. The application processor mainly processes an operating system, a user interface, an application, and the like. The modem processor mainly processes a wireless communication signal, for example, a baseband processor. It may be understood that, in some embodiments, the modem processor may not be integrated into the processor 1010.

The processor 1010 is configured to generate a first signal based on first information, where the first information is sensing-related information; and
the radio frequency unit 1001 is configured to send the first signal.

For example, the first information includes at least one of the following:
a sensing area identifier;
an identifier indicating whether the first signal is used for sensing;
a sensing service identifier;
a sensing service type identifier;
a sensing target identifier;
a tag identifier associated with a sensing target;
a sensing measurement quantity identifier;
a cell identifier;
a device identifier participating in sensing measurement;
time domain resource information;
frequency domain resource information; and
a codeword number.

For example, the sensing area identifier is used to indicate at least one of the following:
a sensing area including a plurality of base station coverage areas;
a sensing area under a single base station coverage area;
a sensing area corresponding to a specific angle range of a single base station; and
a geographical area identifier.

For example, the time domain resource information includes at least one of the following:
a system frame number, a subframe number, a slot number, a symbol number, duration, time domain density, a cyclic prefix CP type, and a CP length; and
the frequency domain resource information includes at least one of the following:
a resource element RE index, a resource block RB index, carrier frequency information, frequency band information, a bandwidth, frequency domain density, and a subcarrier spacing.

For example, the first signal includes at least one of the following:
a signal generated based on a PN sequence;
a signal generated based on a ZC sequence; and
a signal generated based on a chirp signal.

For example, in a case that the first signal includes the signal generated based on the PN sequence, the first information is associated with an initial value of the PN sequence.

For example, in a case that the first signal includes the signal generated based on the ZC sequence, the first information is associated with a root sequence number and/or a cyclic shift value of the ZC sequence.

For example, in a case that the first signal includes the signal generated based on the chirp signal, the first information is associated with a frequency modulation slope and/or a start frequency of the chirp signal.

For example, the radio frequency unit 1001 is further configured to send the first information.

For example, the radio frequency unit 1001 is further configured to send a candidate set of the first information.

The terminal generates the first signal based on the sensing-related information, and then sends the first signal. In this way, a signal applicable to sensing can be generated, and the sensing-related information is carried by using the first signal, so that a receive end can obtain the sensing-related information through detection, and signaling overheads can be reduced.

An embodiment of this application further provides a communication device. The device includes a processor and a communication interface. The communication interface is configured to receive a second signal, where the second signal is a first signal after being transmitted on a channel, the first signal is generated based on first information, and the first information is sensing-related information. This embodiment of the communication device corresponds to the method embodiment on a second device side. Each implementation process and implementation of the method embodiment are applicable to this embodiment of the communication device, and same technical effects can be achieved. For example, FIG. 10 is a schematic diagram of a hardware structure of a terminal serving as a second device for implementing embodiments of this application. A structure of the terminal is described above. Details are not described herein again.

The radio frequency unit 1001 is configured to receive a second signal, where
the second signal is a first signal after being transmitted on a channel, the first signal is generated based on first information, and the first information is sensing-related information.

For example, the first information includes at least one of the following:
a sensing area identifier;
an identifier indicating whether the first signal is used for sensing;
a sensing service identifier;
a sensing service type identifier;
a sensing target identifier;
a tag identifier associated with a sensing target;
a sensing measurement quantity identifier;
a cell identifier;
a device identifier participating in sensing measurement;
time domain resource information;
frequency domain resource information; and
a codeword number.

For example, the sensing area identifier is used to indicate at least one of the following:
a sensing area including a plurality of base station coverage areas;
a sensing area under a single base station coverage area;
a sensing area corresponding to a specific angle range of a single base station; and
a geographical area identifier.

For example, the time domain resource information includes at least one of the following:
a system frame number, a subframe number, a slot number, a symbol number, duration, time domain density, a cyclic prefix CP type, and a CP length; and
the frequency domain resource information includes at least one of the following:
a resource element RE index, a resource block RB index, carrier frequency information, frequency band information, a bandwidth, frequency domain density, and a subcarrier spacing.

For example, the first signal includes at least one of the following:
a signal generated based on a PN sequence;
a signal generated based on a ZC sequence; and
a signal generated based on a chirp signal.

For example, in a case that the first signal includes the signal generated based on the PN sequence, the first information is associated with an initial value of the PN sequence.

For example, in a case that the first signal includes the signal generated based on the ZC sequence, the first information is associated with a root sequence number and/or a cyclic shift value of the ZC sequence.

For example, in a case that the first signal includes the signal generated based on the chirp signal, the first information is associated with a frequency modulation slope and/or a start frequency of the chirp signal.

For example, the processor 1010 is configured to:
generate the first signal based on the first information; and
obtain a sensing measurement result based on the first signal and the second signal.

For example, the radio frequency unit 1001 is further configured to receive the first information; and
the processor 1010 is further configured to: obtain a candidate set of the first information, and detect the second signal based on the candidate set to determine the first information.

For example, the radio frequency unit 1001 is further configured to: in a case that the second signal is detected based on the candidate set to obtain a detection result, and the detection result does not meet a preset threshold or the detection result indicates that a decoding error occurs, send a detection failure indication to the first device.

The detection failure indication is used to indicate the first device to perform at least one of the following:
resending the first signal; and
sending the first information.

For example, the radio frequency unit 1001 is further configured to receive first configuration information, where the first configuration information is used to receive the second signal, and the first configuration information includes at least one of the following:
a signal resource identifier;
a waveform;
a subcarrier spacing;
a guard interval;
time domain resource information and/or frequency domain resource information;
signal power;
sequence information;
a signal direction; and
a quasi co-location relationship.

For example, the radio frequency unit 1001 is further configured to receive second configuration information, where the second configuration information is used for sensing measurement and/or reporting of the sensing measurement result, and the second configuration information includes at least one of the following:
a sensing measurement quantity;
a reported time domain resource and/or a reported frequency domain resource;
a reporting manner; and
a reporting triggering condition.

The second signal received by the terminal is the first signal after being transmitted on the channel, the first signal is generated based on the first information, and the first information is sensing-related information. In this way, the generated first signal is applicable to sensing, and the sensing-related information is carried by using the first signal, so that a receive end can obtain the sensing-related information through detection, and signaling overheads can be reduced.

An embodiment of this application further provides a network side device, including a processor and a communication interface. This embodiment of the network side device corresponds to the method embodiment of the first device or the second device. Each implementation process and implementation of the method embodiment are applicable to this embodiment of the network side device, and same technical effects can be achieved.

For example, an embodiment of this application further provides a network side device. As shown in FIG. 11, the network side device 1100 includes an antenna 111, a radio frequency apparatus 112, a baseband apparatus 113, a processor 114, and a memory 115. The antenna 111 is connected to the radio frequency apparatus 112. In an uplink direction, the radio frequency apparatus 112 receives information through the antenna 111, and sends the received information to the baseband apparatus 113 for processing. In a downlink direction, the baseband apparatus 113 processes information that needs to be sent, and sends processed information to the radio frequency apparatus 112. The radio frequency apparatus 112 processes the received information, and sends processed information through the antenna 111.

In the foregoing embodiment, the method performed by the first device or the second device may be implemented in the baseband apparatus 113. The baseband apparatus 113 includes a baseband processor.

For example, the baseband apparatus 113 may include at least one baseband board. A plurality of chips are disposed on the baseband board. As shown in FIG. 11, one chip is, for example, a baseband processor, and is connected to the memory 115 by using a bus interface, to invoke a program in the memory 115 to perform the operations of the network device shown in the foregoing method embodiment.

The network side device may further include a network interface 116, and the interface is, for example, a common public radio interface (CPRI).

For example, the network side device 1100 in this embodiment of this application further includes instructions or a program that is stored in the memory 115 and that can be run on the processor 114. The processor 114 invokes the instructions or the program in the memory 115 to perform the method performed by the modules shown in FIG. 6, and a same technical effect is achieved. To avoid repetition, details are not described herein again.

An embodiment of this application further provides a readable storage medium. The readable storage medium stores a program or instructions, and the program or the instructions are executed by a processor to implement the processes of the method embodiment performed by the first device or the processes of the method embodiment performed by the second device, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or instructions to implement the processes of the method embodiment performed by the first device or the processes of the method embodiment performed by the second device, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the method embodiment performed by the first device or the processes of the method embodiment performed by the second device, and a same technical effect can be achieved. To avoid repetition, details are not described herein again.

An embodiment of this application further provides a transmission processing system. The system includes a first device and a second device. The first device may be configured to perform the steps of the method performed by the first device, and the second device may be configured to perform the steps of the method performed by the second device.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is an example implementation. Based on such an understanding, the technical solutions of this application essentially or the part contributing to the related art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A transmission processing method, comprising:
generating, by a first device, a first signal based on first information, wherein the first information is sensing-related information; and
sending, by the first device, the first signal.

2. The method according to claim 1, wherein the first information comprises at least one of the following:
a sensing area identifier;
an identifier indicating whether the first signal is used for sensing;
a sensing service identifier;
a sensing service type identifier;
a sensing target identifier;
a tag identifier associated with a sensing target;
a sensing measurement quantity identifier;
a cell identifier;
a device identifier participating in sensing measurement;
time domain resource information;
frequency domain resource information; or
a codeword number.

3. The method according to claim 2, wherein the sensing area identifier is used to indicate at least one of the following:
a sensing area comprising a plurality of base station coverage areas;
a sensing area under a single base station coverage area;
a sensing area corresponding to a specific angle range of a single base station; or
a geographical area identifier.

4. The method according to claim 2, wherein the time domain resource information comprises at least one of the following:
a system frame number, a subframe number, a slot number, a symbol number, duration, time domain density, a cyclic prefix CP type, or a CP length; and
the frequency domain resource information comprises at least one of the following:
a resource element RE index, a resource block RB index, carrier frequency information, frequency band information, a bandwidth, frequency domain density, or a subcarrier spacing.

5. The method according to claim 1, wherein the first signal comprises at least one of the following:
a signal generated based on a PN sequence;
a signal generated based on a ZC sequence; or
a signal generated based on a chirp signal.

6. The method according to claim 5, wherein when the first signal comprises the signal generated based on the PN sequence, the first information is associated with an initial value of the PN sequence.

7. The method according to claim 5, wherein when the first signal comprises the signal generated based on the ZC sequence, the first information is associated with a root sequence number and/or a cyclic shift value of the ZC sequence.

8. The method according to claim 4, wherein when the first signal comprises the signal generated based on the chirp signal, the first information is associated with at least one of a frequency modulation slope or a start frequency of the chirp signal.

9. The method according to claim 1, further comprising:
sending, by the first device, the first information.

10. The method according to claim 1, further comprising:
sending, by the first device, a candidate set of the first information.

11. The method according to claim 1, wherein the first device comprises a base station or a terminal.

12. A transmission processing method, comprising:
receiving, by a second device, a second signal, wherein
the second signal is a first signal after being transmitted on a channel, the first signal is generated based on first information, and the first information is sensing-related information.

13. The method according to claim 12, wherein the first information comprises at least one of the following:
a sensing area identifier;
an identifier indicating whether the first signal is used for sensing;
a sensing service identifier;
a sensing service type identifier;
a sensing target identifier;
a tag identifier associated with a sensing target;
a sensing measurement quantity identifier;
a cell identifier;
a device identifier participating in sensing measurement;
time domain resource information;
frequency domain resource information; or
a codeword number.

14. The method according to claim 12, wherein the first signal comprises at least one of the following:
a signal generated based on a PN sequence;
a signal generated based on a ZC sequence; or
a signal generated based on a chirp signal.

15. The method according to claim 14, wherein when the first signal comprises the signal generated based on the PN sequence, the first information is associated with an initial value of the PN sequence.

16. The method according to claim 14, wherein when the first signal comprises the signal generated based on the ZC sequence, the first information is associated with a root sequence number and/or a cyclic shift value of the ZC sequence.

17. The method according to claim 14, wherein when the first signal comprises the signal generated based on the chirp signal, the first information is associated with at least one of a frequency modulation slope or a start frequency of the chirp signal.

18. The method according to claim 12, wherein after the receiving, by a second device, a second signal, the method further comprises:
generating, by the second device, the first signal based on the first information; and
obtaining, by the second device, a sensing measurement result based on the first signal and the second signal.

19. The method according to claim 18, wherein before the generating, by the second device, the first signal based on the first information, the method further comprises:
receiving, by the second device, the first information; or
obtaining, by the second device, a candidate set of the first information, and detecting the second signal based on the candidate set to determine the first information.

20. A communication device, comprising a processor and a memory, wherein the memory stores a program or instructions, wherein the program or the instructions, when executed by the processor, cause the electronic device to perform operations comprising:
generating a first signal based on first information, wherein the first information is sensing-related information; and
sending the first signal.
